(19) United States
(12) Patent Application Publication
(10) Pub. No.: US 2008/0036728 A1
(43) Pub. Date: Feb. 14, 2008

(54) Multi-segment displays

(76) Inventors: Akihiro Takagi, San Mateo, CA (US); David Williams, San Jose, CA (US); Achintya K. Bhowmik, Milpitas, CA (US); Jim Kardach, Saratoga, CA (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/503,228

(22) Filed: Aug. 10, 2006

(51) Int. Cl. G09G 3/36

(52) U.S. Cl. 345/102

(57) ABSTRACT

A method and system to reduce power consumption of a display includes using a matrix of light sources to illuminate pixels in display segments. The light sources may be light emitting diodes (LED). An LED may be associated with a display segment. The intensity level of an LED may be individually controlled.

### FIELD OF INVENTION

The present invention relates generally to the field of power management; and, more specifically, to techniques for reducing power consumption of displays.

### BACKGROUND

To improve battery life, manufacturers of portable computer systems have been developing techniques to reduce power consumption of electronic components. Studies have shown that a portable computer display may consume as much as 30% to 50% of the total platform average power, depending on the brightness settings. This high level of display power consumption is generally true when the display uses a technology that incorporates a Cold Cathode Fluorescent Lamp (CCFL) backlight. Techniques are being developed to reduce the power consumption of the display.

### BRIEF DESCRIPTION OF THE DRAWINGS

The present invention is illustrated by way of example and not limitation in the accompanying figures in which like references indicate similar elements and in which:

FIG. 1A is a block diagram illustrating an example of a prior art liquid crystal display (LCD) monitor.

FIG. 1B is a block diagram illustrating an example of a prior art liquid crystal (LC) matrix.

FIG. 1C is a block diagram illustrating an example of prior art pixel and sub-pixels.

FIG. 2 illustrates one example of a matrix of light emitting diodes (LED), in accordance with some embodiments.

FIGS. 3A-3B illustrate examples of a color LED and a white LED that may be used to illuminate pixels in a display segment, in accordance with some embodiments.

FIG. 4 illustrates one example of a diffuser segment that may be used, in accordance with some embodiments.

FIGS. 5A-5D illustrate one example of a display implemented using a matrix of LEDs, in accordance with some embodiments.

FIGS. 6A1-6A2 illustrate an example of the intensity levels of red LEDs, in accordance with some embodiments.

FIGS. 6B1-6B2 illustrate an example of the intensity levels of green LEDs, in accordance with some embodiment.

FIGS. 6C1-6C2 illustrate an example of the intensity levels of blue LEDs, in accordance with some embodiments.

FIGS. 7A1-7A2 illustrate an example of the pixel intensity in the display segments using white LEDs, in accordance with some embodiments.

FIG. 8 is a block diagram illustrating an example of a pixel, in accordance with some embodiments.

FIG. 9 is a block diagram illustrating an example of a process that may be used to reduce display power consumption, in accordance with some embodiments.

### DETAILED DESCRIPTION

In some embodiments, a display may include a matrix of light sources. The display may be configured to have multiple display segments. At least one of the light sources may be individually addressable and may be configured to illuminate pixels (picture elements) in a display segment of the display. The intensity level of the light source may be controlled in accordance with characteristics of information to be displayed in an associated display segment.

In the following description, for purposes of explanation, numerous specific details are set forth to provide a thorough understanding of the present invention. It will be evident, however, to one skilled in the art that the present invention may be practiced without these specific details. In other instances, well known structures, processes, and devices are shown in block diagram form or are referred to in a summary manner in order to provide an explanation without undue detail.

### Display System

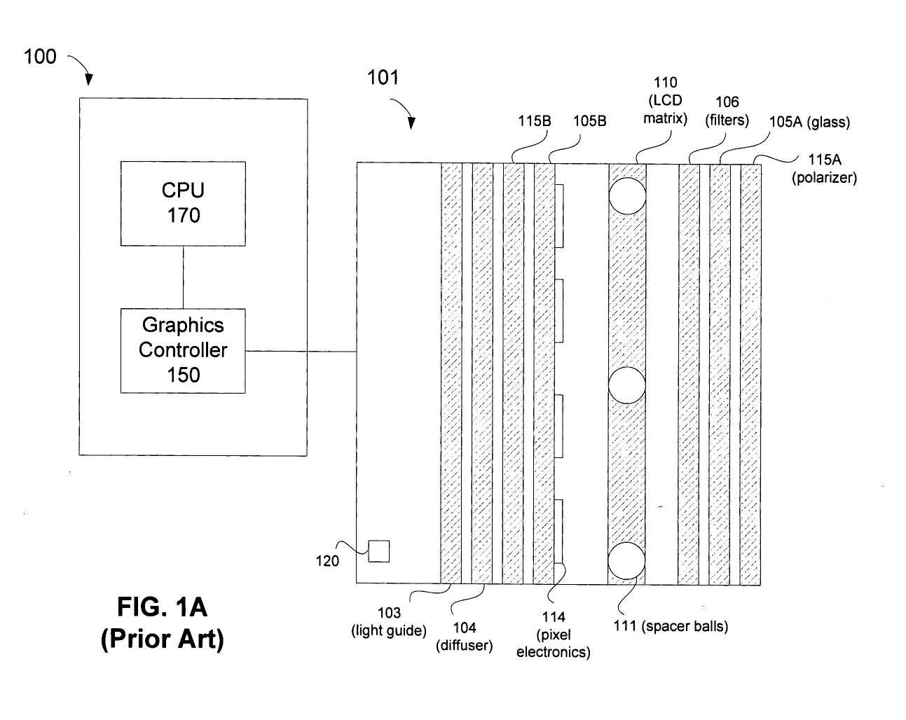

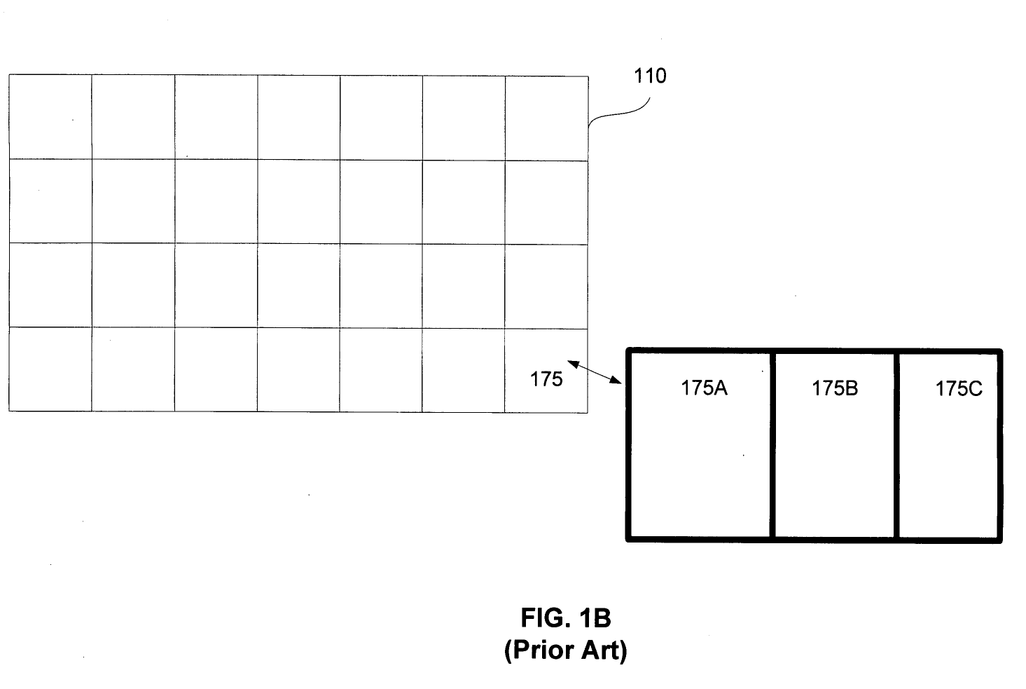

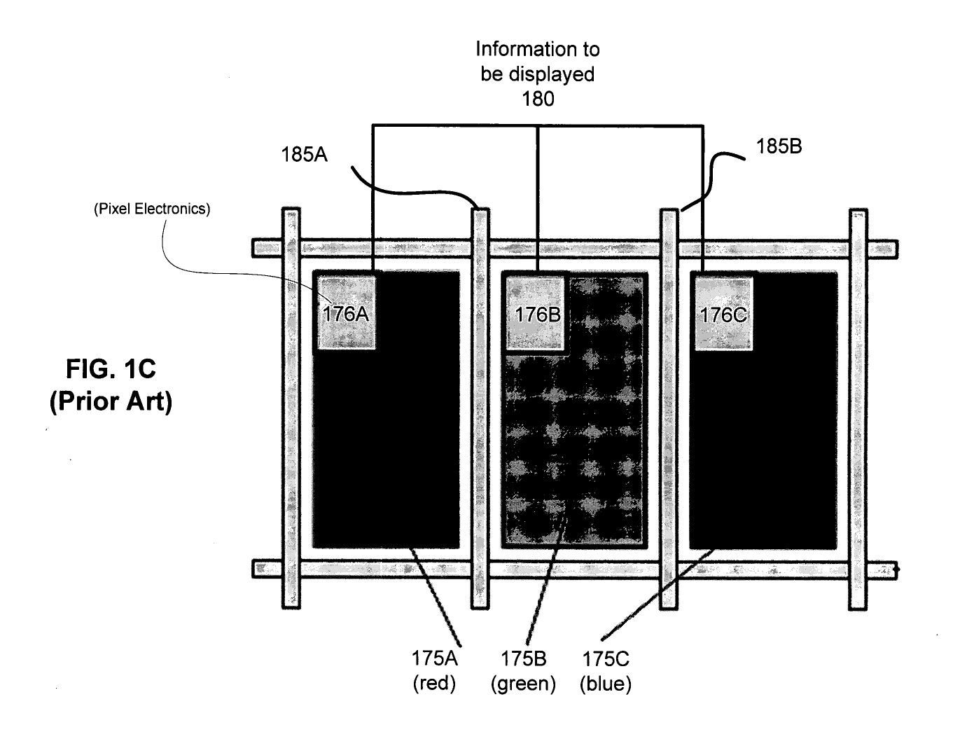

FIG. 1A is a block diagram illustrating an example of a prior art display system. The display system may include a color LCD monitor. Typically, from the front, LCD monitor 101 may include a first polarizer 115A, a first glass substrate 105A, color filters 106, a LC matrix 110 and spacer balls 111, a second glass substrate 105B, a second polarizer 115B, a light guide 103, and a light diffuser 104. The color filters 106 may be etched onto the first glass substrate 105A. The second glass substrate 105B may include pixels electronics 114. The pixel electronics 114 may include transistors and storage capacitors (not shown) and may be used to control light passing through the LC matrix 110. On each side of the LC matrix 110 may be an alignment film (not shown).

A light source 120 (also referred to as a back light) may be positioned near the light guide 103. Light from the light source 120 is transmitted by the light guide 103 and the light diffuser 104 to the light polarizer 115B. The light polarizer 115B may then distribute the light uniformly to the LC matrix 110. Display data may be delivered to the LCD monitor 101 by a graphics controller 150 associated with a processor 160 within computer system 100. Although not shown, the computer system 100 may also include other components (e.g., memory, bus, etc.) that may be used to control information to be displayed on the LCD monitor 101.

The LC matrix 110 (also referred to as a thin film transistor (TFT) matrix) may include multiple cells, as illustrated in an example in FIG. 1B. Each cell may represent a pixel such as, for example, pixel 175. Each pixel from the LC matrix 110 may be associated with pixel electronics (not shown). Typically, in a color LCD, each pixel is comprised of three sub-pixels. For example, the pixel 175 may include sub-pixels 175A, 175B and 175C. The higher the resolution of the LCD monitor 101, the higher the number of pixels (and accordingly the number of sub-pixels) and the higher the number of pixel electronics. For example, for an LCD display with XGA (extended graphics array) resolution, the number of pixels may be 1024×768×3 with the last multiplier “3” reflecting the number of sub-pixels.

Each sub-pixel may be associated with a primary color (e.g., red, green, or blue). The pixel electronics 114 may include a transistor that acts as a switch to control the light passing through each of the sub-pixels. The light that passes through may then go through the color filters 106 which may filter all colors except for the primary color that the sub-pixel is associated with. The color filters (also referred to as micro-filters) 106 may be integrated into the first glass substrate 105A. For example, the sub-pixels 175A, 175B and 175C may be associated with a red, green, and blue filter, respectively. This is illustrated in an example in FIG. 1C. The amount of light that the pixel electronics 176A allow passing through the sub-pixel 175A (associated with the red filter) depends on the characteristics of the information to be displayed at the pixel 175. For example, when information 180 is to be displayed (at the pixel 175) in a specific color, the pixel electronics 176A, 176B and 176C may allow different levels of light to pass through to the three sub-pixels 175A, 175B and 175C, respectively. In this example, the combination of the different light level passing through the sub-pixels 175A, 175B and 175C (and filtered by the red, green and blue filters, respectively) may be viewed by a user as the intended color (e.g., gray).

It may be noted that the information 180 may be delivered to the pixel 175 at every frame interval (also referred to as a frame refresh rate), and the color of the information 180 is displayed to the user via the red, green and blue filters at the same time during the frame interval. For example, when the frame refresh rate is 60 Hz, the colors red, green, and blue may also be transmitted via the sub-pixels 175A, 175B and 175C simultaneously at 60 Hz and until the next frame refresh.

As illustrated in FIG. 1C, the sub-pixels 175A, 175B and 175C may be separated from one another by vertical grid lines 185A and 185B. There may also be horizontal and vertical grid lines separating adjacent pixels. These grid lines may be wires associated one or more sub-pixels within the LC matrix 110. For example, the wires may be used to carry signals to the pixel electronics 176A, 176B and 176C. When there are more pixels (e.g., higher resolution), there are more wires. The number of wires may occupy a large percentage of the LC matrix 110 and may substantially block the light that is delivered by the light polarizer 115B. In addition to the wires, the pixel electronics 176A, 176B and 176C may also block the light that is delivered by the light polarizer 115B.

Let aperture ratio be defined as a percentage of an LCD display that may not be blocked by any pixel electronics and grid lines, the following formula may provide an approximation of such a ratio:

$$Aperture Ratio = \frac{{A}_{Pixel}}{{A}_{Pixel} + {A}_{TFT} + {A}_{Line}} ,$$

where A_{Pixel} is the transmissive area of the pixel, A_{TFT} is the area occupied by the TFT (or pixel electronics) in each pixel, and A_{Line} is the area occupied by the row and column grid lines for each pixel. For a high definition LCD display having a resolution of 1920×1080 pixels and with each pixel including three sub-pixels, the aperture ratio may be approximately 60%. To compensate for the low aperture ratio, the intensity level of the light source 120 may need to be increased to increase the brightness. This may result in higher power consumption.

### Matrix of Light Sources

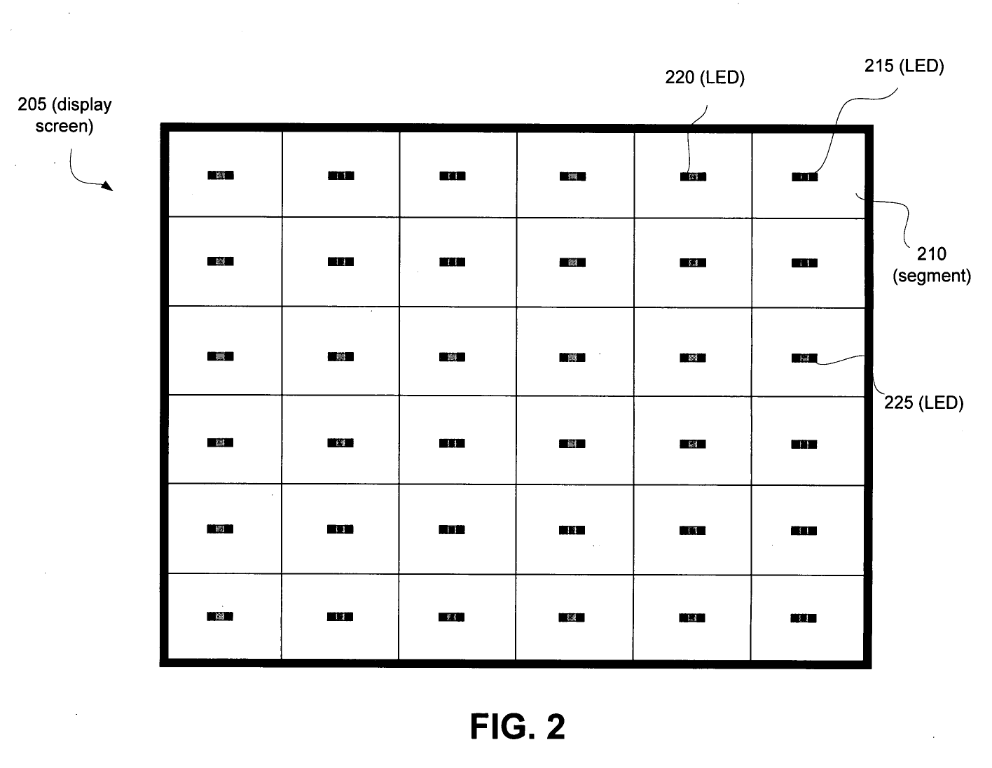

FIG. 2 illustrates one example of a matrix of light sources, in accordance with some embodiments. A light source may be a light emitting diode (LED). A display may be associated with a matrix of light sources. The display may include multiple display segments. A display segment may be associated with multiple pixels. One light source may be used to illuminate pixels in one display segment. In the current example, display 205 may be configured to include 36 display segments. Each display segment is illustrated as one block such as, for example, display segment 210. In this example, there is a 6×6 matrix of LEDs (for a total of 36), with each LED being associated with a display segment. For example, LED 215 is associated with the display segment 210.

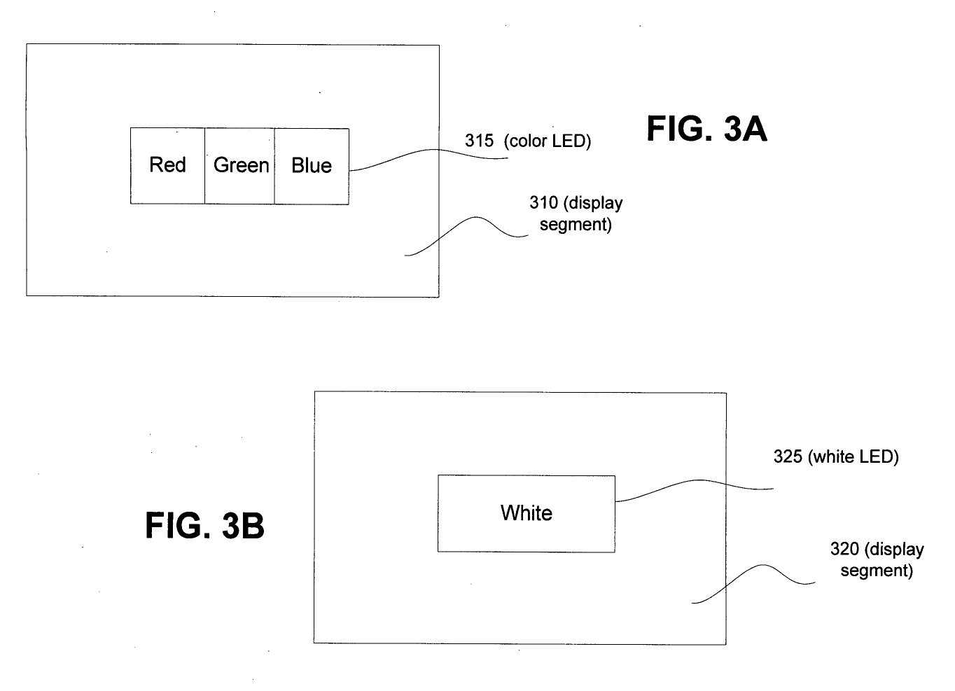

For some embodiments, the intensity level or brightness of a light source may be individually controlled. In the example when the light sources are LEDs, the intensity level of the LED 215 may be different from the intensity level of the LED 220 and from the intensity level of the LED 225. Different techniques may be used to control the intensity level of a LED. For some embodiments, a light source may be a color LED. This is illustrated in FIG. 3A with the color LED 315 used to illuminate pixels in display segment 310. In this example, the color LED 315 may include a red LED, a green LED, and a blue LED. Alternatively, a light source may be a white LED. This is illustrated in FIG. 3B with the white LED 325 used to illuminate pixels in display segment 320.

### Diffuser

A matrix of light sources may be associated with a diffuser. For some embodiments, a diffuser may be configured to have multiple diffuser segments, and a diffuser segment may be associated with a display segment. Light emitted from one light source may be constrained by a diffuser segment to illuminate pixels in the associated display segment. For example, referring to FIG. 2, a diffuser may be configured so that the LED 215 is used to illuminate only pixels in the associated display segment 210, and not pixels in any other neighboring display segments. Similarly, light emitted from the LED 220 or from the LED 225 is controlled by the diffuser such that it does not illuminate the pixels in the display segment 210.

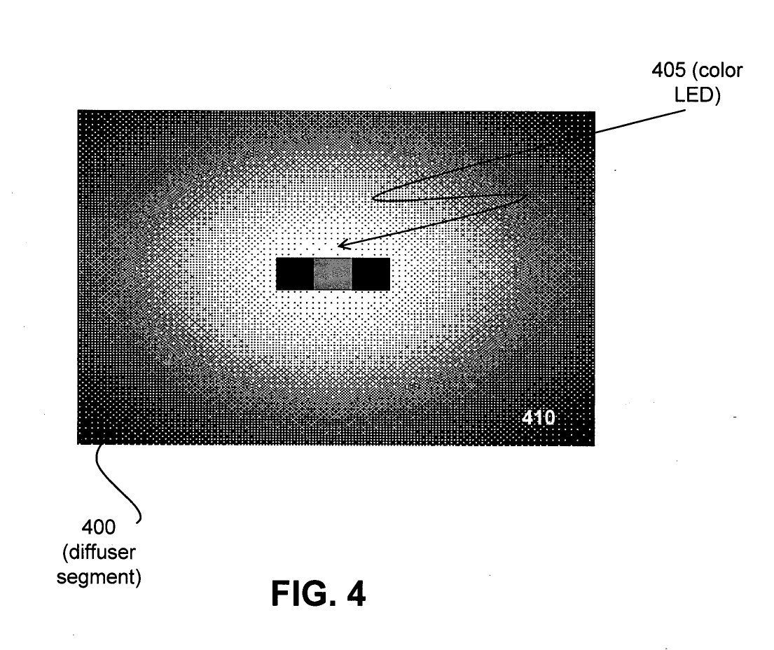

FIG. 4 illustrates one example of a diffuser segment that may be used, in accordance with some embodiments. A diffuser segment may be associated with a display segment and at least one light source. In this example, diffuser segment 400 may be used to distribute light illuminated by LED 405 over an associated display segment. The diffuser segment 400 may be positioned in front of the LED 405. Dark region 410 near edges of the diffuser segment 400 may indicate higher density of blemishes on the surface of the diffuser segment 400. When the light from the LED 405 reaches the dark region 410, the light may be scattered by the blemishes, and the dark region 410 (or the blemish portions of the diffuser segment 400) may become bright. For some embodiments, when a region of a diffuser segment includes higher density of blemishes, more light may be scattered. Similarly, when a region of a diffuser segment includes lesser density of blemishes, less light may be scattered.

When the LED 405 is placed approximately near or at the center of the diffuser segment 400 and the density of blemish is equally the same across the diffuser segment 400, the center region of the diffuser segment 400 may be brighter than any other regions, resulting in non-uniform distribution of light. For some embodiments, the distribution of light may be more uniform by using a diffuser segment configured to have regions with different levels of blemish density. Regions of a diffuser segment that receive more light may have fewer blemishes, while regions of the diffuser segment that receive less light may have more blemishes.

For some embodiments, some diffuser segments in a diffuser may be configured differently from the others. A diffuser segment may be configured based on shape of an associated light source. For example, when the shape of the light source is rectangle, the diffuser segment may be configured with a blemish density gradient according to the rectangular form of the light source. The blemish density may be higher toward the perimeter of the diffuser segment, and it may be lowest at the center of the diffuser segment.

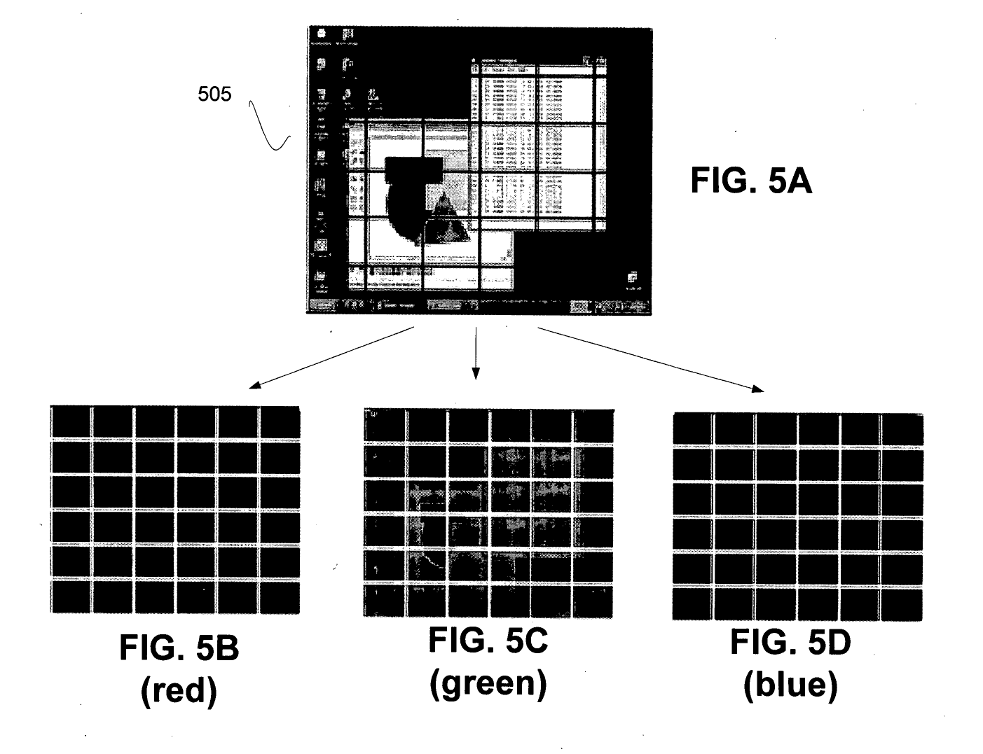

FIG. 5A illustrates information displayed on a display in colors, in accordance with some embodiments. Display 505 may be implemented using a matrix of light sources. The light sources may be color LEDs. Light from the color LEDs may be used to display the information on the display segments of the display 505. For example, some information may be displayed in gray, while some other information may be displayed in white. Depending on the characteristics (e.g., color, style, etc.) of the information, there may be one or more primary color components used to display the information.

FIG. 5B illustrates an example of the information displayed on the display 505 in the red primary color. It may be noted that some display segments may include more red color information than others, while some display segments may not include any red color information. FIG. 5C illustrates an example of the information displayed on the display 505 in the green primary color. It may be noted that some display segments may include more green color information than others, while some display segments may not include any green color information. FIG. 5D illustrates an example of the information displayed on the display 505 in the blue primary color. It may be noted that some display segments may include more blue color information than others, while some display segments may not include any blue color information.

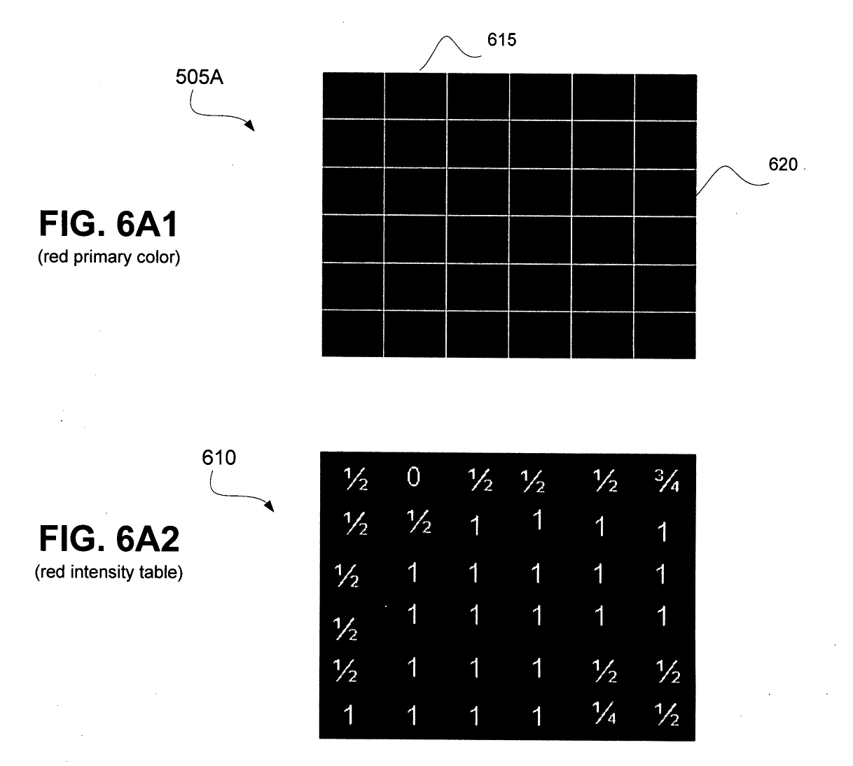

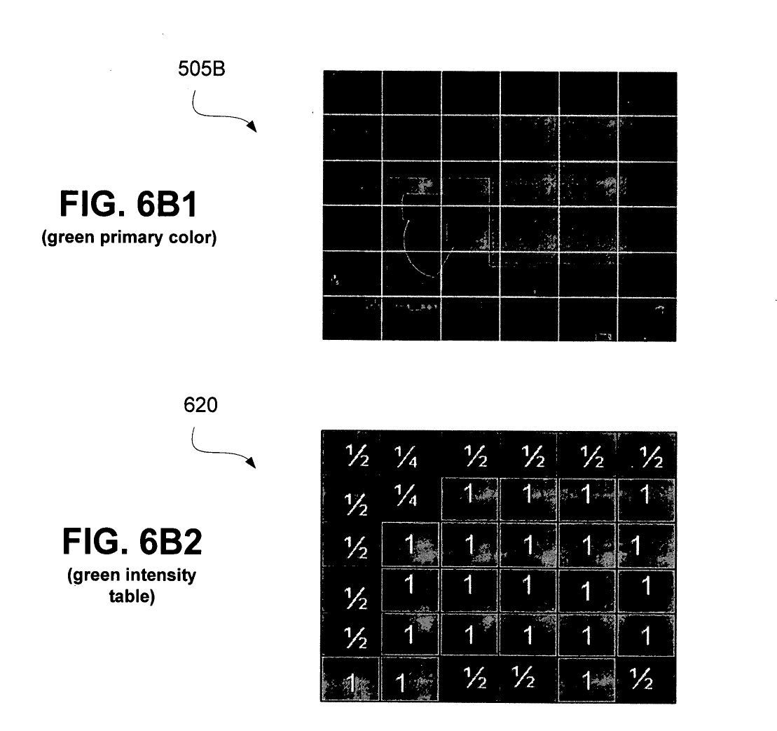

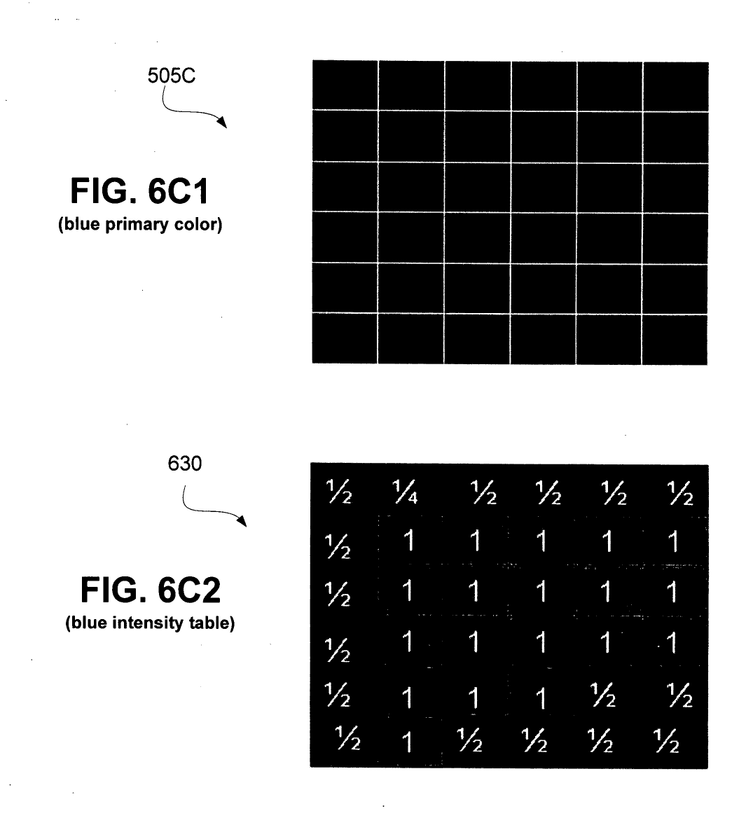

FIGS. 6A1-6C2 illustrate examples of intensity levels of different color LEDs, in accordance with some embodiments. FIGS. 6A1-6A2 illustrate an example of the intensity levels of red LEDs. In this example, FIG. 6A1 is similar to FIG. 5B and illustrates display segments of the display 505A in the red primary color. FIG. 6A2 illustrates red color table 610. Each entry in the red color table 610 may correspond to a display segment of the display 505A. The value of each entry in the red color table 610 may depend on the red color information in the corresponding display segment. For example, when a display segment does not include any red color information, the entry associated with that display segment has a value “0”. When a display segment includes some red color information, the entry associated with that display segment has a value other than “0”. The other values may be “¼”, “½”, and “¾”, each corresponding to more red color information than the one before. For example, since the display segment 615 does not include any red color information, the entry associated with the display segment 615 has a value “0”, as illustrated in the red color table 610. The value of each entry in the red color table 610 may also be used to control the intensity levels of the red LEDs. The value “0” may correspond to a lowest intensity level and a lowest power consumption level. The value “1” may correspond to a highest intensity level and a highest power consumption level. Although five intensity levels are used in this example, different intensity levels may also be used. Controlling the intensity levels of the red LEDs may help controlling the power consumption of a display. This is in contrast with previous backlight techniques where the intensity level of the single light source may be set at a level equivalent to a high value.

The example in FIG. 6A2 includes 36 display segments. Comparing with the potential of having to set the intensity level of a red LED associated with each display segment to a high value of “1”, a power usage ratio using different intensity levels may be calculated as follows:

Red power usage ratio=(total red intensity levels)/36=(number of display segments having intensity level “1”+number of display segments having intensity level “¾”+number of display segments having intensity level “½”+number of display segments having intensity level “¼”+number of display segments having intensity level “0”)/36=28/36=0.78 or 78% (a potential power savings of 100-78=22%)

FIGS. 6B1-6B2 illustrate an example of the intensity levels of green LEDs, in accordance with some embodiments. In this example, FIG. 6B1 is similar to FIG. 5C and illustrates display segments of the display 505B in the green primary color. FIG. 6B2 illustrates green color table 620. Each entry in the green color table 620 may correspond to a display segment of the display 505B. The value of each entry in the green color table 620 may depend on the green color information in the corresponding display segment. Using the same formula used for the red LEDs, the power usage ratio by using different intensity levels for the green LEDs may be calculated as follows:

$$\begin{matrix}\begin{matrix}Green power \\ usage ratio\end{matrix} = ( total green pixel intensity levels ) / 36 \\ = ( 1 \times 22 + \frac{1}{2} \times 12 + \frac{1}{4} \times 2 ) / 36 = 28.5 / 36 \\ = 0.79 or 79 \% \\ ( a potential power savings of 100 - 79 = 21 \% )\end{matrix}$$

FIGS. 6C1-6C2 illustrate an example of the intensity levels of blue LEDs, in accordance with some embodiments. In this example, FIG. 6C1 is similar to FIG. 5D and illustrates display segments of the display 505C in blue primary color. FIG. 6C2 illustrates blue color table 630. Each entry in the blue color table 630 may correspond to a display segment of the display 505C. The value of each entry in the blue color table 630 may depend on the blue color information in the corresponding display segment. Using the same formula used for the red LEDs, the power usage ratio by using different intensity levels for the green LEDs may be calculated as follows:

$$\begin{matrix}\begin{matrix}Blue power \\ usage ratio\end{matrix} = ( total blue pixel intensity levels ) / 36 \\ = ( 1 \times 19 + \frac{1}{2} \times 16 + \frac{1}{4} ) / 36 = 27.25 / 36 \\ = 0.76 or 76 \% \\ ( a potential power savings of 100 - 79 = 24 \% )\end{matrix}$$

As illustrated in the examples in FIGS. 6A1-6C2, for each primary color, less than 80% of the intensity level may be required (as compared to having the highest intensity level), resulting in at least 20% reduction in power consumption.

For some embodiments, additional reduction of power consumption may be achieved by displaying a shade of a primary color instead of a black color. For example, instead of using a black background, a shade of a primary color may be used. As another example, instead of displaying information in the white color, an off-white color may be used. By using less of the black or the white color, it may be possible to reduce the intensity level of one or more primary colors in some display segments, yielding further power consumption.

For some embodiments, additional reduction of power consumption may be achieved by adopting a green on black display scheme. Generally, human eyes are not as sensitive to color in darker shades. For example, instead of displaying a background in dark black color, it may be better to display the background in a greenish black color. This may enable reducing intensity levels associated with red LEDs and blue LEDs, thus achieving more power savings.

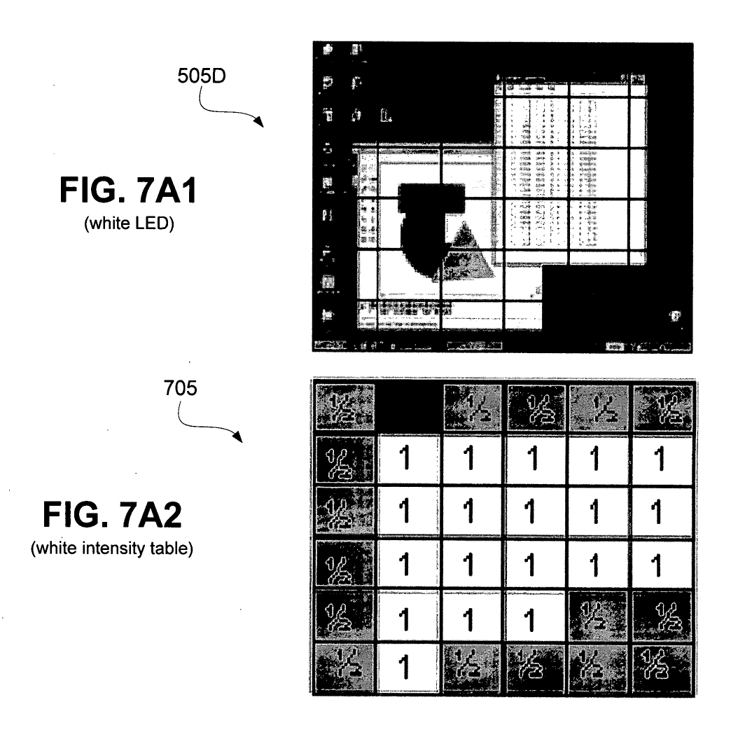

FIGS. 7A1-7A2 illustrate an example of the intensity levels in the display segments using white LEDs, in accordance with some embodiments. In this example, FIG. 7A1 illustrates display segments of the display 505D in white. The matrix of light sources may include white LEDs instead of color LEDs. FIG. 7A2 illustrates white color table 705. Each entry in the white color table 705 may correspond to a display segment of the display 505D. The value of each entry in the white color table 705 may depend on the white color information in the corresponding display segment. Note that since this example uses white LEDs, there is no splitting of the primary colors (R, G, B) triplet as illustrated in FIGS. 6A1-6C2. Using the same formula used for the red LEDs, the power usage ratio by using different intensity levels for the white LEDs may be calculated as follows:

$$\begin{matrix}\begin{matrix}White power \\ usage ratio\end{matrix} = ( total white pixel intensity levels ) / 36 \\ = ( 1 \times 19 + \frac{1}{2} \times 16 + \frac{1}{4} ) / 36 = 27.25 / 36 \\ = 0.76 or 76 \% \\ ( a potential power savings of 100 - 79 = 24 \% )\end{matrix}$$

### Field Sequential Color

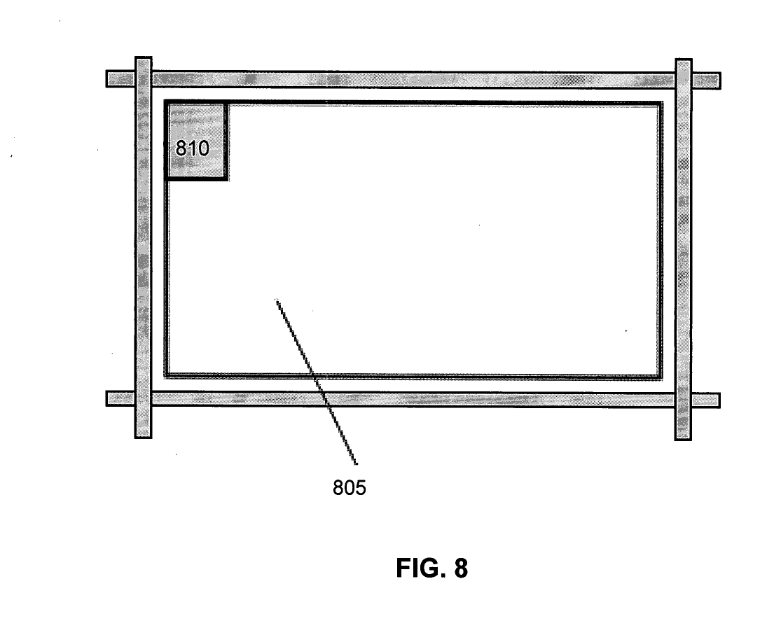

FIG. 8 is a block diagram illustrating an example of a pixel, in accordance with some embodiments. Pixel 805 may be different from the pixel described in the example in FIG. 1C because the pixel 805 may not include three sub-pixels and wires separating the three sub-pixels. As previously described in FIG. 1C, the intensity level of the light source may need to be increased to compensate for the blockage caused by the sub-pixels and their associated electronics. When not using sub-pixels, the overall number of pixels may be reduced by approximately three times. For example, the pixel 805 may need only one pixel electronics 810 (instead of three) to control the light passing through the pixel 805. The reduction in the number of pixels and the reduction in the number of grid lines (e.g., wires) may significantly reduce the blockage of light and may enhance the brightness of the display. The formula to approximate the aperture ratio described above may be adjusted as:

$$Aperture Ratio = \frac{{A}_{Pixel}}{{A}_{Pixel} + \frac{1}{3} ( {A}_{TFT} + {A}_{Line} )} ,$$

where the ⅓ factor is applied to reflect the reduction in the number of pixel electronics and grid lines. When a display has 1920×1080 pixels, the aperture ratio using the current technique may be greater than 80%.

For some embodiments, a pixel such as, for example, the pixel 805 may be used with a white light source and a field sequential color (FSC) filter to display information in color. The FSC filter (not shown) may include a red color segment, a green color segment, and a blue color segment. When the white light reaches the red color segment, only the red color passes through; when the white light reaches the green color segment, only the green color passes through; when the white light reaches the blue color segment, only the blue color passes through. There may be one FSC filter for each display segment. At any one time, the information displayed on a display implemented using this technique may be all red, all green, or all blue. The FSC filter may be implemented using a rotating cylinder, a rotating disc, or any implementation that may enable one primary color to pass through at a time. The concept of FSC is known to one skilled in the art. The FSC filter may be used in place of a conventional filter as described in FIG. 1A.

For display brightness similar to a conventional display implemented with sub-pixels, the power consumption associated with using the white light sources together with the FSC scheme may be reduced by approximately 20% (FSC scheme at 80%−Conventional scheme at 60%). When the aperture ratio using the conventional scheme is 65%, the aperture ratio using the FSC scheme may be approximately 88%. This may mean that approximately 35% more aperture ratio may be achieved using white light sources with the FSC scheme as compared to using color light sources with the conventional scheme. More aperture ratio may correspond to fewer blockages and more brightness, and therefore lower need to compensate for the blockages by increasing the intensity of the light sources, thus reducing power consumption.

### Process

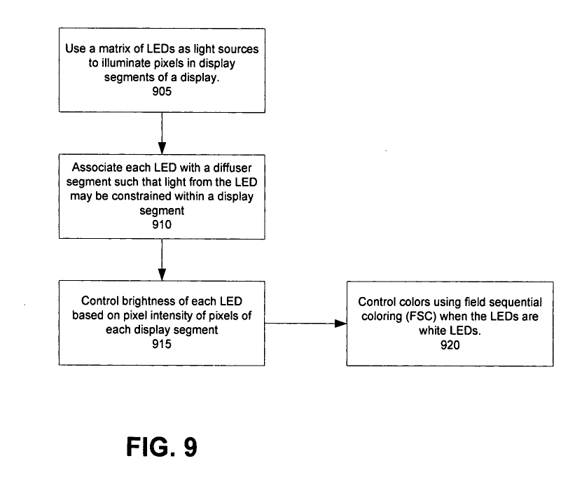

FIG. 9 is a block diagram illustrating an example of a process that may be used to reduce display power consumption, in accordance with some embodiments. White LEDs as described in FIGS. 7A1 and 7A2 are used in this example. At block 905, a matrix of white LEDs may be used as light sources to illuminate pixels in display segments of a display. At block 910, each white LED may be associated with a diffuser segment. There may be multiple diffuser segments. Each diffuser segment may be configured to constraint light from a white LED to within an associated display segment. For some embodiments, there may be one white LED per diffuser segment and per display segment. At block 915, the intensity level of a white LED may be controlled based on the characteristics of the information displayed in an associated display segment. To display the information in colors, FSC filters may be used with the white LEDs, as shown in block 920.

The process described in FIG. 9 may also be used when the light sources are color LEDs. In this situation, the operations performed in block 915 may include controlling the intensity levels of the red LEDs, green LEDs, and blue LEDs based on the characteristics of the information displayed in the associated display segments. When the color LEDs are used, it may not be necessary to use the FSC filters.

### Computer Readable Media

The operations of these various methods may be implemented by a processor in a computer system, which executes sequences of computer program instructions that are stored in a memory which may be considered to be a machine-readable storage media. The memory may be random access memory, read only memory, a persistent storage memory, such as mass storage device or any combination of these devices. Execution of the sequences of instruction may cause the processor to perform operations according to the process described in FIG. 9, for example.

The instructions may be loaded into memory of the computer system from a storage device or from one or more other computer systems (e.g. a server computer system) over a network connection. The instructions may be stored concurrently in several storage devices (e.g. DRAM and a hard disk, such as virtual memory). Consequently, the execution of these instructions may be performed directly by the processor. In other cases, the instructions may not be performed directly or they may not be directly executable by the processor. Under these circumstances, the executions may be executed by causing the processor to execute an interpreter that interprets the instructions, or by causing the processor to execute a compiler which converts the received instructions to instructions that which can be directly executed by the processor. In other embodiments, hard-wired circuitry may be used in place of or in combination with software instructions to implement the present invention. Thus, the present invention is not limited to any specific combination of hardware circuitry and software, nor to any particular source for the instructions executed by the computer system.

Although some embodiments of the present invention have been described with reference to specific exemplary embodiments, it will be evident that various modifications and changes may be made to these embodiments without departing from the broader spirit and scope of the invention as set forth in the claims. For example, although some embodiments have been described as having display segments being of similar size, it may be possible that some of display segments may have different sizes. Accordingly, the specification and drawings are to be regarded in an illustrative rather than a restrictive sense.

What is claimed is:

1. A method, comprising:
using a matrix of two or more light sources to illuminate pixels in display segments of a display, wherein each light source is associated with a diffuser segment to constraint light from the light source to a display segment.

2. The method of claim 1, wherein using the matrix of two or more light sources to illuminate the pixels in the display segments comprises:
controlling intensity level of each light source based on characteristic of information to be displayed in a display segment.

3. The method of claim 2, wherein the intensity level of each light source is individually controllable.

4. The method of claim 3, wherein the diffuser segment includes at least one region with high blemish density and at least one region with low blemish density.

5. The method of claim 4, wherein the light source is a light emitting diode (LED).

6. The method of claim 5, wherein the light source is a color LED comprising of a first primary color LED, a second primary color LED, and a third primary color LED.

7. The method of claim 6, wherein the intensity level of the light source is controlled by controlling intensity level of at least one of the first primary color LED, the second primary color LED, and the third primary color LED.

8. The method of claim 5, wherein the light source is a white LED.

9. The method of claim 8, wherein a field sequential color (FSC) scheme is used with the white LED to result in a first primary color, a second primary color, and a third primary color.

10. The method of claim 9, wherein pixels in the display segment include no sub-pixels.

11. An apparatus, comprising:
a matrix of light emitting diodes (LED), each LED associated with one of multiple display segments of a display; and
a diffuser coupled to the matrix of LEDs, light from each LED constrained by one of multiple diffuser segments of the diffuser to illuminate pixels in one associated display segment.

12. The apparatus of claim 11, wherein each of the diffuser segments is to include a low blemish density region and a high blemish density region.

13. The apparatus of claim 12, wherein each of the LEDs is a color LED comprising of a first primary color LED, a second primary color LED, and a third primary color LED.

14. The apparatus of claim 13, wherein intensity level of each of the first primary color LED, the second primary color LED, and the third primary color LED is individually controllable.

15. The apparatus of claim 12, wherein each of the LEDs is a white LED, and wherein intensity level of each white LED is individually controllable.

16. The apparatus of claim 15, wherein each white LED is coupled with a field sequential color (FSC) filter.

17. A system, comprising:
means for using a matrix of light sources to illuminate pixels in display segments of a display; and
means for individually controlling intensity of the light sources based on characteristics of information to be displayed in the display segments.

18. The system of claim 17, wherein the means for using the matrix of light sources to illuminate the pixels in the display segments comprises:
means for constraining light from one light source to illuminate pixels in one display segment.

19. The system of claim 18, wherein the light sources include color light emitting diodes (LED), and wherein the means for individually controlling the intensity of a light source comprises means for controlling intensity of a first primary color LED, a second primary color LED, and a third primary color LED.

20. The system of claim 18, wherein the light sources include white light emitting diodes (LED).

21. The system of claim 20, further comprising:
means for using the white LEDs with a field sequential color scheme to enable displaying the information in colors.
